(19) United States
(12) Patent Application Publication
(10) Pub. No.: US 2008/0086375 A1
(43) Pub. Date: Apr. 10, 2008

(54) METHOD OF AND SYSTEM FOR DIRECTORY-ASSISTANCE-BASED MARKETING

(76) Inventors: Gary Steck, Blue Bell, PA (US); Brad Schorer, Collegeville, PA (US)

Correspondence Address: WINSTEAD PC, P.O. BOX 50784, DALLAS, TX, 75201, US

(21) Appl. No.: 11/862,995

(22) Filed: Sep. 27, 2007

Related U.S. Application Data
(60) Provisional application No. 60/828,152, filed on Oct. 4, 2006.

(51) Int. Cl. G06Q 30/00

(52) U.S. Cl. 705/14

(57) ABSTRACT

A method of intelligent marketing in response to a directory-assistance call from a caller. The method includes receiving a directory-assistance response from the caller, determining call attributes of the directory-assistance call, accessing, utilizing at least some of the call attributes, a profile of the caller, selecting at least one advertisement based, at least in part, on the profile and presenting, to the caller, the at least one selected advertisement and a listing responsive to the directory-assistance response.

### CROSS-REFERENCE TO RELATED APPLICATIONS

This patent application claims priority from, and incorporates by reference the entire disclosure of, U.S. Provisional Patent Application No. 60/828,152, filed Oct. 4, 2006.

### BACKGROUND

1. Technical Field

The present invention relates in general to the field of directory assistance, and in particular, to directory-assistance-based intelligent marketing by providing marketing information to a directory-assistance caller based upon information gathered from the caller.

2. History of Related Art

Directory assistance has existed virtually since the onset of the public switched telephone system. In the beginning, operators manually found listings according to a caller's request. As telephone networks grew in complexity, increased demand for directory-assistance followed and automation became necessary to control costs associated with providing listing information to callers. Modern directory-assistance automation has continued to progress throughout the years.

Currently most phone systems charge for the lookup of names, addresses and numbers of general or specific businesses. This can be costly and many telephone customers find such directory-assistance charges to be excessive. There is also a current need for many businesses to market to consumers with targeted advertisements. This can be done efficiently through the use of Standard Industry Codes (SIC). By knowing exactly what a particular consumer is looking for at a particular moment, a company can target the consumer's scope of interest with an advertisement.

U.S. Pat. No. 4,850,007 to Marino (“Marino”) discloses a system for providing a telephone toll service in which a telephone subscriber selects the service by sending an appropriate signal and then dialing a directory-assistance call or other telephone toll call. After the caller's options are determined, and typically before signaling for the call is commenced, a recorded-announcement of an aural or visual nature is connected to the subscriber's line, with the announcement consisting of at least one advertisement. The advertisements are selected from a databank according to some predetermined technique of selection, which may include any number of factors or features to make the service attractive to subscribers and of a nature to make the service also sufficiently rewarding to advertisers.

U.S. Pat. No. 5,852,775 to Hidary (“Hidary”) discloses a cellular telephone system that is provided with an ad server and a memory for holding various commercial messages. The messages are either generic or are tailored for specific demographically selected subscribers or geographic cells. When communication is established either between a subscriber or a non-subscriber, at least one of them receives either a generic or a specific commercial message.

### SUMMARY OF THE INVENTION

A method of intelligent marketing in response to a directory-assistance call from a caller. The method includes receiving a directory-assistance response from the caller, determining call attributes of the directory-assistance call, accessing, utilizing at least some of the call attributes, a profile of the caller, selecting at least one advertisement based, at least in part, on the profile and presenting, to the caller, the at least one selected advertisement and a listing responsive to the directory-assistance response.

A directory-assistance-based intelligent-marketing system. The system includes a directory-assistance system adapted to receive an audible directory-assistance response from a caller, determine call attributes of the directory-assistance call, and present to the caller at least one advertisement and a listing responsive to the directory-assistance response. The system further includes a marketing data analysis system adapted to access, utilizing the call attributes, a profile of the caller and select the at least one advertisement based, at least in part, on the profile and wherein the directory-assistance system and the marketing data analysis system are interoperably coupled.

An article of manufacture for intelligent marketing operating on a network, the article of manufacture including at least one computer readable medium and processor instructions contained on the at least one computer readable medium, the processor instructions configured to be readable from the at least one computer readable medium by at least one processor and thereby cause the at least one processor to operate as to receive a directory-assistance response from the caller, determine call attributes of the directory-assistance call, access, utilizing at least some of the call attributes, a profile of the caller, select at least one advertisement based, at least in part, on the profile and present, to the caller, the at least one selected advertisement and a listing responsive to the directory-assistance response.

A method of intelligent marketing in response to a directory-assistance call from a caller, the method includes receiving, by a directory-assistance system, a directory-assistance response from the caller, determining call attributes of the directory-assistance call, receiving, from a marketing data-analysis system, a profile of the caller, receiving, from the marketing data-analysis system, information related to at least one advertisement based, at least in part, on the profile and presenting, to the caller, the at least one advertisement and a listing responsive to the directory-assistance response.

A method of intelligent marketing in response to a directory-assistance call from a caller, the method includes receiving, from a directory-assistance system, call attributes of the directory-assistance call, accessing, utilizing at least some of the call attributes, a profile of the caller, selecting at least one advertisement based, at least in part, on the profile and forwarding, to the directory-assistance system, the at least one advertisement.

### BRIEF DESCRIPTION OF THE DRAWINGS

A more complete understanding of the method and system of the present invention may be obtained by reference to the following Detailed Description when taken in conjunction with the accompanying Drawings wherein:

FIG. 1 is a block diagram of a directory-assistance-based marketing system;

FIG. 2 is a block diagram of a directory-assistance system;

FIG. 3 is a block diagram of a marketing data analysis system; and

FIG. 4 is a flow diagram of a directory-assistance-based intelligent-marketing process.

### DETAILED DESCRIPTION OF ILLUSTRATIVE EMBODIMENTS OF THE INVENTION

Various embodiments of the present invention will now be described more fully with reference to the accompanying drawings. The invention may, however, be embodied in many different forms and should not be constructed as limited to the embodiments set forth herein; rather, the embodiments are provided so that this disclosure will be thorough and complete, and will fully convey the scope of the invention to those skilled in the art.

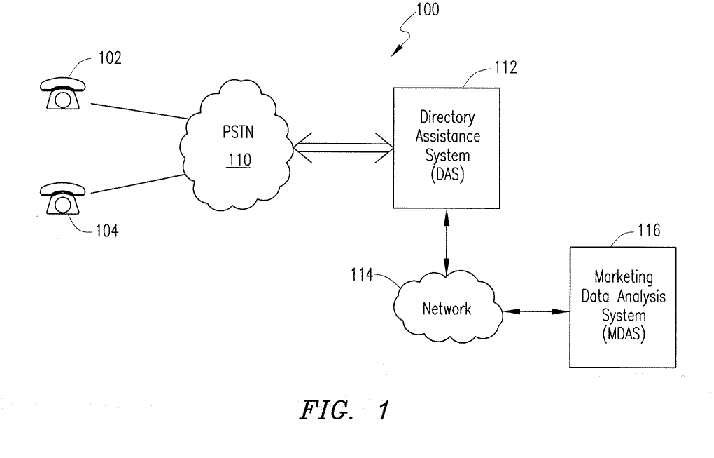

FIG. 1 shows a block diagram of a directory-assistance-based intelligent-marketing system 100. A public switched telephone network (PSTN) 110 provides callers associated with communication devices 102, 104 access to a directory-assistance system (DAS) 112. The communication devices 102, 104 may be, for example, wireline telephones or wireless telephones. Although described in conjunction with the PSTN 110, concepts of the invention are equally applicable to wireless or internet telephony directory-assistance. The DAS 112 is connected to a marketing data analysis system (MDAS) 116 via a network 114. Callers 102, 104 are connected to the DAS 14 via a switch (not explicitly shown).

When a caller associated with a communications device 102, 104 places a call requesting directory assistance, the switch (not explicitly shown) routes the call to appropriate circuitry within the DAS 112. The directory-assistance call may be, for example, a call made to determine a specific wireline or wireless telephone number and/or address of a residence or business. The directory-assistance call may come from, for example, a wireline telephone, a wireless (cellular) telephone, a VoIP (Internet) telephone, a Satellite telephone or a personal computer. For example, the caller 102, 104 may reach the DAS 112 by dialing a specific phone number such as, for example, 1-800-CALLERS. After connection to the DAS 112 has been established, the DAS 112 gathers information from the directory-assistance call. The information gathered may be, for example, caller name, caller phone number, caller location, type of directory assistance required, and any other pertinent information related to the call or the caller 102, 104. In some embodiments, at least some of the information may be determined via a variety of means such as, for example, caller ID, calling number area code and exchange code, wireless phone encoded location, and the like.

The information gathered by the DAS 112 is forwarded to the MDAS 116 via the network 114. The data transmission between the DAS 112 and the MDAS 116 typically occurs in real-time or near real-time. The MDAS 116 is adapted to create a profile for each caller 102, 104. The profile for each caller includes historical records for the caller 102, 104. The historical records comprise data related to previous interactions of the caller when requesting directory-assistance. The data may include, for example, requested listing by the caller, time of call, caller number, and the like. The historical records help the directory-assistance-based intelligent-marketing system 100 to better assess what a particular caller 102, 104 may be interested in at the moment. Better assessment of what a particular caller 102, 104 is interested in at the moment allows the directory-assistance-based intelligent-marketing system 100 to effectively target the caller's scope of interest with an advertisement. The MDAS 116 is further adapted to analyze and store the information received from the DAS 112 to create historical records for each caller 102, 104. The historical records for each caller 102, 104 are associated with the profile for each caller 102, 104. The MDAS 116 is also adapted to update the profile each time the caller 102, 104 places a call requesting directory-assistance.

In general, the DAS 112 initially processes the directory-assistance call and either routes or processes the call as necessary to provide a telephone number corresponding to a requested listing and locality along with marketing information such as, for example, advertisements. The advertisements may be, for example, a recorded announcement of an aural or visual nature. The advertisements to be presented to the caller 102, 104 are selected in an intelligent manner from a plurality of advertisements by assessing the caller's profile at the MDAS 116. For example, if a caller 102, 104 places a call to the DAS 112 and is interested in obtaining the number for a pizza restaurant, an advertisement for pizza specials in the caller's locality will likely have a much higher impact on the caller and be received with a much higher level of interest than by someone who is merely watching the evening news and is presented a televised advertisement for a pizza restaurant. The intelligent marketing is achieved by accessing the profile for the caller stored at the MDAS 116. In some embodiments, the advertisements may be presented to the caller 102, 104 via, for example, a recorded announcement, a text message, an e-mail message, an SMS message, printed flyers, or any other suitable means.

The directory-assistance-based intelligent-marketing system 100 is adapted to intelligently control the type of advertisements and when the advertisements are presented to the caller 102, 104. The directory-assistance-based intelligent-marketing system 100 captures information from a directory-assistance call, verifies the captured information, performs comparisons, stores the captured information, and creates and updates the profiles for each caller 102, 104. This functionality enables the directory-assistance-based intelligent-marketing system 100 to not only service the caller's request for directory-assistance but also enables the directory-assistance-based intelligent-marketing system 100 to develop and update the profile of each caller 102, 104 so that the caller 102, 104 can be presented with advertisements in an intelligent manner.

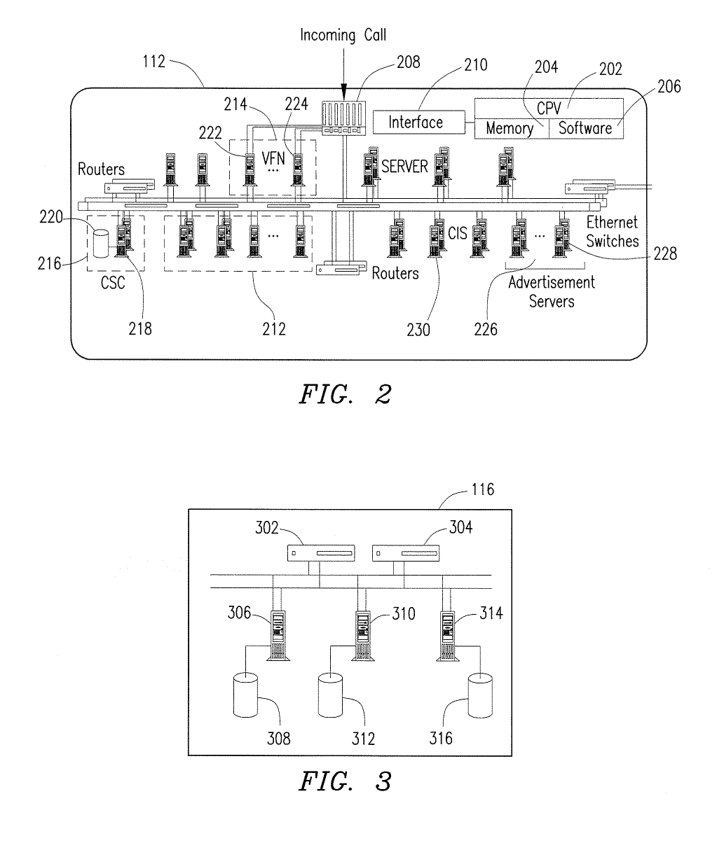

FIG. 2 is a block diagram of the directory-assistance system 112. The DAS 112 includes a central processing unit (CPU) 202 having memory 204 with software 206 to control operation of the DAS 112. Typically, the CPU 202 is associated with a network interface 210 for communication over, for example, a packet-switched network with systems such as, for example, the MDAS 116. The DAS 112 further includes a telephony interface 208, which may be, for example, a switch. The telephony interface 208 is provided to interact with the caller 102, 104 over a telephonic connection. The CPU 202 may include or be associated with necessary hardware and software to provide greetings to the caller 102, 104, ask the caller 102, 104 for desired listings and locality, and store and forward the caller's response. The CPU 202 and the software 206 are configured to facilitate directory-assistance operations by interacting with components within the DAS 112.

The DAS 112 further includes call screening circuitry (CSC) 216 and a voice feature node (VFN) 214. The CSC 216 includes a server 218 and a database 220. The CSC 216 is adapted to determine attributes of a call. The call attributes may include, for example, telephone number of the caller, name of the caller, location of the caller, and the like. The VFN 214 includes a plurality of servers 222, 224. The VFN 214 receives the call attributes from the CSC 216 and prompts the caller 102, 104 for a business listing and locality. The VFN 214 recognizes the business listing and locality from the caller 102, 104 using, for example, a speech recognition system 224. The speech recognition system 224 recognizes and interprets spoken language from caller 102, 104. In an exemplary embodiment, the speech recognition system 224 may be implemented as a server running the WINDOWS XP operating system from Microsoft Corporation or other suitable operating systems such as, for example, Unix, Linux, and the like. The speech recognition system 224 may also include special hardware, as known in the art, for assisting in recognizing speech patterns. The speech recognition system 224 may also execute one or more programs specifically designed to implement various functions of embodiments of the present invention. Such programs may be written in any standard programming language such as, for example, C or C++. Those having skill in the art will appreciate that the recognition of the business listing and locality is not limited to a speech recognition system 224 and can instead be achieved via a variety of systems such as, for example, live operator systems.

The DAS 112 further includes a plurality of advertisement servers 226, 228. The advertisement servers 226, 228 are adapted to communicate with the MDAS 116 and the VFN 214. The advertisement servers 226, 228 store a plurality of advertisements that may be presented to the caller 102, 104. For example, the advertisements to be presented to the caller 102, 104 may be selected by reviewing the caller's profile at the MDAS 116 and the business listing and locality recognized by the VFN 214. In some embodiments, the type of advertisements to be presented are controlled to a highly specific degree. For example, if a caller 102, 104 places a call to the DAS 112 and is interested in obtaining the number for a pizza restaurant, a plurality of advertisements for pizza specials in the caller's locality may be presented. This feature of intelligently selecting advertisements to be presented to the caller 102, 104 based, for example, upon the caller's preferences makes the directory-assistance-based intelligent-marketing system 100 attractive for callers and advertisers.

In an exemplary embodiment, at least three advertisements are presented to the caller 102, 104 for pizza specials in the caller's locality. The three advertisements to be presented are selected from a plurality of advertisements stored in the plurality of advertisement servers 226, 228. The selection is made by the directory-assistance-based intelligent-marketing system 100 by accessing the caller's profile within the MDAS 116.

For example, if the profile of a particular caller 102, 104 indicates that the caller 102, 104 has in the past only used a particular pizza restaurant such as, for example, PIZZA HUT for ordering pizza, the directory-assistance-based intelligent-marketing system 100 may select the three best specials offered by PIZZA HUT in the caller's locality to be presented to the caller. However, if the profile of the caller 102, 104 indicates that the caller 102, 104 has in the past ordered pizzas from a pizza restaurant running the best specials, the directory-assistance-based intelligent-marketing system 100 might instead select the three best pizza specials in the caller's locality to be presented to the caller 102, 104.

In another exemplary embodiment, if the profile of a particular caller 102, 104 indicates that each time the caller 102, 104 places a directory-assistance call via a wireless telephone, the caller 102, 104 has in the past only used a particular pizza restaurant at a particular location such as, for example, DOMINOS for ordering pizza, the directory-assistance-based intelligent-marketing system 100 might select specials offered by DOMINOS in that particular location to be presented to the caller 102, 104. Additionally, if the profile of a particular caller 102, 104 indicates that each time the caller places a directory-assistance call after a particular time such as, for example, 9.00 PM, the caller 102, 104 has in the past only used a particular Chinese restaurant at a particular location, the directory-assistance-based intelligent-marketing system 100 might select specials offered by the Chinese restaurant at the particular location to be presented to the caller 102, 104.

Thus, the advertisements to be presented to the caller 102, 104 are selected in an intelligent manner by accessing and reviewing the caller's profile within the MDAS 116. In various embodiments, the caller 102, 104 may navigate through the advertisements and select a particular advertisement which may be of interest. In other instances, the caller 102, 104 may navigate through the advertisements and not select any of the advertisements and may wait to be connected to the requested listing.

Referring again to FIG. 2, the VFN 214 is adapted to monitor and capture the navigation habits of the caller 102, 104. The captured navigation-habit information is temporarily stored in a memory within a call information server (CIS) 230. The captured navigation-habit information may include, for example, caller location, requested listing, requested locality, advertisement presented, advertisement selected, advertisement delivery options, advertisement delivery selection, call date and time, and the like. The captured navigation-habit information is stored in the CIS 230 for a predetermined time period, after which the captured navigation-habit information is transferred to the MDAS 116 via the network 114. In various embodiments, data transmission between the CIS 230 and the MDAS 116 takes place using, for example, XML, or another language-specific format. In some embodiments, data transmission between the CIS 230 and the MDAS 116 may take place using connection-oriented or connection-less communication protocols such as, for example, HTTP, TCP/IP, FTP, etc. The data transmission between the CIS 230 and the MDAS 116 typically occurs in real-time or near real-time. The MDAS 116 is adapted to analyze and store the information received from the DAS 112 to create and/or update the profile of the caller 102, 104.

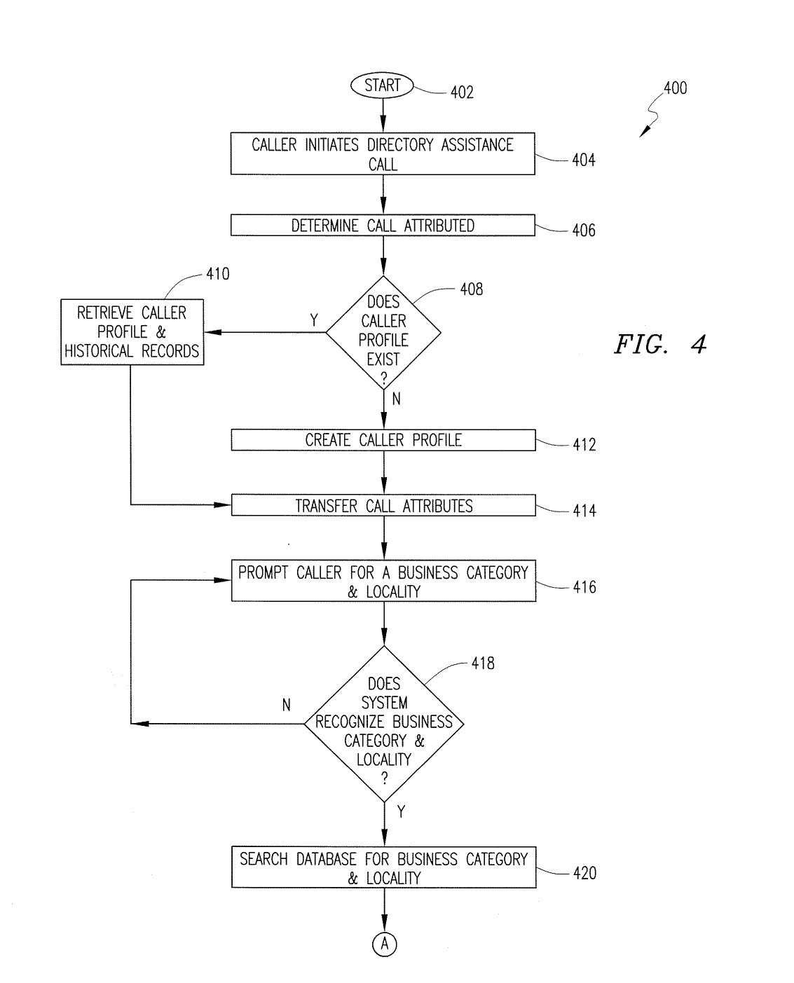

FIG. 3 is a block diagram of the marketing data analysis system (MDAS) 116. The MDAS 116 includes a datamatch server 306. The datamatch server 306 is associated with at least one database 308. In addition, the MDAS 116 includes a plurality of datastore servers 310, 314. Each one of the datastore servers 310, 314 is associated with at least one database 312, 316. In various embodiments, the databases 308, 312, 316 may be implemented using, for example, Oracle™, MS Access™ databases, MS SQL, IBM DB2, and the like. For exemplary purposes, only three servers 306, 310, 314 and three databases 308, 312, 316 are shown; however, any number of servers and databases may be present within the MDAS 116 as needed.

The MDAS 116 further includes a plurality of routers 302, 304. The routers 302, 304 are adapted to communicate with the network 114 to transfer data between the DAS 112 and MDAS 116. In various embodiments, data transmission between the DAS 112 and the MDAS 116 takes place using, for example, XML, or another language-specific format. In some embodiments, data transmission between the DAS 112 and the MDAS 116 may take place using connection-oriented or connection-less communication protocols such as, for example, HTTP, TCP/IP, FTP, etc. The data transmission between the DAS 112 and the MDAS 116 typically occurs in real-time or near real-time.

The MDAS 116 is adapted to receive captured information from the CIS 230. The captured information may include, for example, caller telephone number, requested listing, requested locality, advertisement presented, advertisement selected by the caller 102, 104, advertisement delivery options, advertisement delivery selection, call date and time, and the like. The captured information is stored within the database 308 connected to the datamatch server 306. The datamatch server 306 uses the caller's telephone number to perform a reverse look-up operation. For example, the datamatch server 306 queries the databases 312, 314 within the MDAS 116 to associate the caller's telephone number with a name and address. The call details for each caller 102, 104 are then amended to contain the name and address of the caller 102, 104. The amended information is updated and stored into the caller's profile and stored within at least one of the databases 312, 316. The databases 312, 316 are adapted to store profiles for each caller 102, 104. The profiles and historical records associated with the profiles are updated every time the caller 102, 104 places a call requesting directory-assistance. The profiles help the directory-assistance-based intelligent-marketing system 100 determine what a particular caller 102, 104 is interested in at the moment and which advertisement(s) to present to the caller 102, 104. By better assessment of what a particular caller 102, 104 is interested in at the moment, the directory-assistance-based marketing system 100 targets the caller's scope of interest with advertisements.

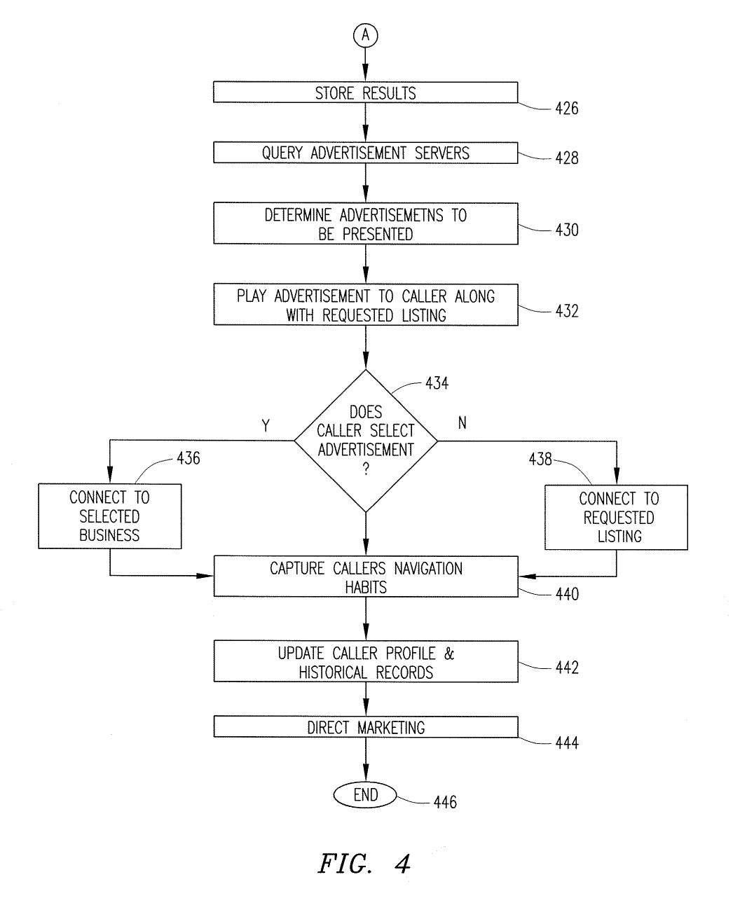

FIG. 4 is a flow diagram of a directory-assistance-based intelligent-marketing process. For illustrative purposes, a process 400 will be described in conjunction with FIGS. 1-3. The process 400 starts at step 402. At step 404, a caller associated with one of the communication devices 102, 104 places a call to the directory-assistance-based intelligent-marketing system 100 requesting information. At step 406, call attributes are determined by the call screening circuitry (CSC) 216 within the DAS 112. The call attributes may include, for example, telephone number of the caller, name of the caller, and the like. At step 408, it is determined whether a profile for the caller already exists. The profile may be stored, for example, within at least one of the databases 312, 316. If it is determined at step 408 that no caller profile already exists, the process 400 proceeds to step 412. At step 412, a profile for the caller is created and stored, for example, within at least one of the databases 312, 316 and the process 400 proceeds to step 414. However, if it is determined at step 408 that a profile for the caller already exists, the profile and historical records associated with the profile are retrieved at step 410. The process 400 proceeds to step 414 from steps 410 and 412.

At step 414, the call attributes are transferred to the voice feature node (VFN) 214 within the DAS 112. After receiving the call attributes at step 414, the VFN 214 prompts the caller 102, 104 for a business listing and locality at step 416. In some embodiments, the VFN 214 utilizes a speech recognition system 224 to recognize the business listing and locality from the caller 102, 104. The speech recognition system 224 recognizes and interprets spoken language from caller 102, 104. At step 418, it is determined whether the speech recognition system 224 recognizes the business listing and locality from the caller 102, 104. If it is determined at step 418 that the speech recognition system 224 has failed to recognize the business listing and locality from the caller 102, 104, the process 400 returns to step 416. However, if it is determined at step 418 that the speech recognition system 224 has recognized the business listing and locality, the process 400 proceeds to step 426.

At step 426, the number for the business listing and locality requested by the caller 102, 104 is stored. At step 428, the VFN 214 launches a query to the advertisement servers 226, 228 to select at least one advertisement most relevant to the caller's preferences. At step 430, at least one advertisement most relevant to the caller's preference is selected in order to be presented to the caller 102, 104 is selected. The advertisement servers 226, 228 store a plurality of advertisements that may be presented to the caller 102, 104. For example, the advertisements to be presented to the caller 102, 104 are selected based on by access of the caller's profile at the MDAS 116 and the business listing and locality recognized by the VFN 214. The type of advertisements can be controlled to a highly specific degree. For example, if a caller 102, 104 places a call to the DAS 112 and is interested in obtaining the number for a pizza restaurant, a plurality of advertisement for pizza specials in the caller's locality may be presented. In some embodiments, the directory-assistance-based intelligent-marketing system 100 is adapted to intelligently control the type of advertisements and when and in what form the advertisements are presented to the caller 102, 104.

At step 432, the at least one selected advertisement is presented to the caller 102, 104 along with the requested listing. In some embodiments, the requested listing may be presented to the caller 102, 104 via, for example, a recorded announcement, a text message, an e-mail message, an SMS message, or any other suitable means. At step 434, it is determined if the caller 102, 104 has selected the at least one advertisement presented to the caller 102, 104. If it is determined at step 432 that the caller 102, 104 has not selected at least one of the at least one advertisement, the process 400 proceeds to step 438. At step 438, the caller 102, 104 is connected to the initially requested listing. However, if it is determined at step 434 that the caller 102, 104 has selected at least one of the at least one advertisement presented, the caller 102, 104 is connected at step 436, for example, to the business running the at least one advertisement. The process 400 proceeds from steps 436 and 438 to step 440.

At step 440, navigation-habit information of the caller 102, 104 are captured by the VFN 214. The captured navigation-habit information is temporarily stored in a memory within the call information server (CIS) 230. The captured navigation-habit information may include, for example, caller location, requested listing, requested locality, advertisement presented, advertisement selected, advertisement delivery options, advertisement delivery selection, call date and time, and the like. The captured navigation-habit information is stored in the CIS 230 for a predetermined time period. At step 442, the captured navigation-habit information is transferred to the MDAS 116 via the network 114 wherein the caller profile is updated with the captured navigation-habit information.

The process 400 proceeds from step 442 to step 444. At step 444, further direct-marketing activities may be performed. For example, the caller profile may be retrieved at pre-determined intervals. The pre-determined intervals may be defined by, for example, advertisers. The retrieved data may be forwarded to a print facility to generate personalized mail such as, for example, coupons, offers, and the like to be presented to the caller 102, 104 as, for example, flyers, direct-mail pieces e-mail messages, SMS messages, and the like. The process 400 ends at step 446. Step 444 is optional and in some embodiments, the process 400 may proceed from step 442 to step 446 without performing step 444.

Those having skill in the art will appreciate that the method and system as disclosed is not limited to directory-assistance calls and can be implemented on calls placed by callers requesting other information such as, for example, movie listings, movie times, insurance information, and the like. Principles of the invention may be applied to any automated system that permits callers to obtain information therefrom.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method of intelligent marketing in response to a directory-assistance call from a caller, the method comprising:
receiving a directory-assistance response from the caller;
determining call attributes of the directory-assistance call;
accessing, utilizing at least some of the call attributes, a profile of the caller;
selecting at least one advertisement based, at least in part, on the profile; and
presenting, to the caller, the at least one selected advertisement and a listing responsive to the directory-assistance response.

2. The method according to claim 1, further comprising monitoring navigation habits of the caller after the at least one selected advertisement has been presented to the caller.

3. The method according to claim 2, further comprising updating the profile of the caller based upon the navigation habits.

4. The method according to claim 2, wherein the navigation habits comprise a selection made by the caller of at least one of the at least one selected advertisement presented to the caller.

5. The method according to claim 4, further comprising providing access to a service associated with the at least one advertisement responsive to the selection made by the caller.

6. The method according to claim 1, wherein the call attributes comprise a caller name, a caller phone number, a caller location, and a time of the directory-assistance call.

7. The method according to claim 1, wherein the profile comprises historical records of the caller, the historical records comprising data related to previous interactions of the caller when requesting directory assistance.

8. The method according to claim 1, further comprising updating the profile responsive to the caller placing a subsequent directory-assistance call.

9. The method according to claim 1, further comprising generating a profile for the caller responsive to a determination that no profile for the caller already exists.

10. The method according to claim 1, further comprising updating the profile for the caller using the call attributes.

11. A directory-assistance-based intelligent-marketing system comprising:
a directory-assistance system adapted to receive an audible directory-assistance response from a caller, determine call attributes of the directory-assistance call, and present to the caller at least one advertisement and a listing responsive to the directory-assistance response;
a marketing data analysis system adapted to access, utilizing the call attributes, a profile of the caller and select the at least one advertisement based, at least in part, on the profile; and
wherein the directory-assistance system and the marketing data analysis system are interoperably coupled.

12. The system according to claim 11, wherein the directory-assistance system comprises:
a central processing unit (CPU) having a network interface;
a telephony interface adapted to interact with the caller;
a voice feature node (VFN) adapted to monitor navigation habits of the caller after the at least one selected advertisement has been presented to the caller;
a call information server (CIS) adapted to temporarily store the monitored navigation habits of the caller;
a call screening circuitry (CSC) adapted to determine the call attributes; and
a plurality of advertisement servers adapted to store a plurality of advertisements.

13. The system according to claim 12, wherein the call information server is adapted to transfer the stored monitored navigation habits of the caller to the marketing data analysis system.

14. The system according to claim 13, wherein the marketing data analysis system comprises at least one database adapted to store the monitored navigation habits of the caller.

15. The system according to claim 14, wherein the marketing data analysis system is adapted to update the profile of the caller based upon the navigation habits.

16. The system according to claim 12, wherein the navigation habits comprise a selection made by the caller of at least one of the at least one selected advertisement presented to the caller.

17. The system according to claim 11, wherein the profile comprises historical records of the caller.

18. The system according to claim 17, wherein the historical records comprise data related to previous interactions of the caller when requesting directory-assistance.

19. The system according to claim 11, wherein the marketing data analysis system is adapted to update the profile of the caller responsive to the caller placing a subsequent directory-assistance call.

20. The system according to claim 12, wherein the call attributes comprise a caller name, a caller phone number, a caller location, and a time of the directory-assistance call.

21. The system according to claim 11, wherein the marketing data analysis system is adapted generate a profile for the caller responsive to a determination that no profile for the caller already exists.

22. The system according to claim 11, wherein the marketing data analysis system is adapted to update the profile for the caller using the call attributes.

23. An article of manufacture for intelligent marketing operating on a network, the article of manufacture comprising:
at least one computer readable medium;
processor instructions contained on the at least one computer readable medium, the processor instructions configured to be readable from the at least one computer readable medium by at least one processor and thereby cause the at least one processor to operate as to:
receive a directory-assistance response from the caller;
determine call attributes of the directory-assistance call;
access, utilizing at least some of the call attributes, a profile of the caller;
select at least one advertisement based, at least in part, on the profile; and
present, to the caller, the at least one selected advertisement and a listing responsive to the directory-assistance response.

24. A method of intelligent marketing in response to a directory-assistance call from a caller, the method comprising:
receiving, by a directory-assistance system, a directory-assistance response from the caller;
determining call attributes of the directory-assistance call;
receiving, from a marketing data-analysis system, a profile of the caller;
receiving, from the marketing data-analysis system, information related to at least one advertisement based, at least in part, on the profile; and
presenting, to the caller, the at least one advertisement and a listing responsive to the directory-assistance response.

25. A method of intelligent marketing in response to a directory-assistance call from a caller, the method comprising:
receiving, from a directory-assistance system, call attributes of the directory-assistance call;
accessing, utilizing at least some of the call attributes, a profile of the caller;
selecting at least one advertisement based, at least in part, on the profile; and
forwarding, to the directory-assistance system, the at least one advertisement.
